(19) United States
(12) Patent Application Publication
(10) Pub. No.: US 2026/0359821 A1
(43) Pub. Date: Nov. 12, 2026

(54) EMBEDDED WATERMARKING AND TRACKING OF BIOMETRIC IMAGES

(71) Applicant: QUALCOMM Incorporated, San Diego, CA (US)

(72) Inventors: Mohamed Imtiaz AHMED, Escondido, CA (US); Suhail JALIL, San Diego, CA (US); Archana SHRIVASTAVA, San Diego, CA (US); Arun MENON, San Diego, CA (US); Ge WANG, Del Mar, CA (US)

(21) Appl. No.: 19/669,878

(22) Filed: May 6, 2026

Related U.S. Application Data
(60) Provisional application No. 64/000,956, filed on Mar. 9, 2026.
(60) Provisional application No. 63/804,318, filed on May 12, 2025.

(51) Int. Cl. G06Q 20/40; G06T 1/00; G06V 40/40; G06V 40/12

(52) U.S. Cl. CPC G06Q 20/40145; G06T 1/0085; G06V 40/45; G06V 40/1382

(57) ABSTRACT

Some disclosed methods may involve obtaining a biometric image from a user via a biometric sensor system of a first device, producing a watermarked encrypted biometric image via a control system, and providing the watermarked encrypted biometric image to a second device for authentication. The watermarked encrypted biometric image may be produced by either (i) encrypting the biometric image to produce an encrypted biometric image and adding a watermark to the encrypted biometric image, or (ii) adding a watermark to the biometric image to produce a watermarked biometric image and encrypting the watermarked biometric image. The control system may be implemented entirely within a single device, such as a cell phone or a biometric module, or the control system functionality may be distributed across multiple devices, such as a biometric module and a payment terminal or a cell phone and a server.

### PRIORITY CLAIMS

This application claims priority to United States Provisional Patent Application No. 63/804,318, filed on May 12, 2025 and entitled “EMBEDDED WATERMARKING AND TRACKING OF BIOMETRIC IMAGES FOR PAYMENT TERMINALS,” and to United States Provisional Patent Application No. 64/000,956, filed on Mar. 9, 2026 and entitled “EMBEDDED WATERMARKING AND TRACKING OF BIOMETRIC IMAGES FOR PAYMENT TERMINALS,” both of which are hereby incorporated in their entireties and for all purposes.

### TECHNICAL FIELD

This disclosure relates generally to methods, apparatus and systems involving the use of biometrics to enable personalized service or for authentication, e.g., to access a payment terminal.

### DESCRIPTION OF THE RELATED TECHNOLOGY

Biometric authentication can be an important feature for controlling access to devices, etc. Many existing products include some type of biometric authentication, including but not limited to fingerprint-based authentication, facial recognition, etc. Technically savvy hackers revel in defeating the latest authentication devices and methods. For example, some premium-tier mobile phone manufacturers have had smartphones that incorporated fingerprint-based authentication systems successfully hacked shortly after product introduction. Hackers have also devised methods for stealing biometric images and using these images to obtain unauthorized access to devices and systems. Improved methods, devices and systems for biometric authentication would be desirable.

### SUMMARY

The systems, methods and devices of the disclosure each have several innovative aspects, no single one of which is solely responsible for the desirable attributes disclosed herein. This document describes many examples that involve payment terminals to describe various disclosed innovations and claims. A person of ordinary skill in the art will appreciate that these teachings may be readily applied to other biometric-authenticated use cases.

Some innovative aspects of the subject matter described in this disclosure may be implemented in an apparatus. In some examples, the apparatus may include a control system and a biometric sensor system configured to obtain a biometric image from a user . The control system may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

The control system may be configured to produce a watermarked encrypted biometric image. In some examples, to produce the watermarked encrypted biometric image, the control system may be configured to encrypt the biometric image to produce an encrypted biometric image and to add a watermark to the encrypted biometric image. Alternatively, or additionally, to produce the watermarked encrypted biometric image, the control system may be configured to add the watermark to the biometric image to produce a watermarked biometric image and to encrypt the watermarked biometric image. The control system may be configured to provide the watermarked encrypted biometric image to a second device for authentication. According to some examples, the second device may be a payment terminal, an access control terminal or a server.

The watermark may be visible or invisible, depending on the implementation. In some examples, the watermark may vary over time. The watermark may cover an entire area of the encrypted biometric image or a partial area of the encrypted biometric image. In some examples, the watermark may encode at least one of a timestamp, an apparatus identifier, a payment terminal identifier, a session identifier, a nonce, or a value associated with a pairing between the apparatus and the payment terminal. According to some examples, the control system may be configured to receive a personalized watermark from another device, such as a user mobile device, and to add the personalized watermark to the biometric image. In some examples, the control system may be configured to attach a hash message authentication code to the watermarked encrypted biometric image.

The biometric sensor system may be configured to obtain a plurality of biometric images from the user. The watermark may be spread across the plurality of biometric images. The control system may be configured to buffer the plurality of biometric images and to include, with a preceding biometric image of the plurality of biometric images, a hash of a subsequent biometric image of the plurality of biometric images.

In some examples, the control system may be configured to provide one or more encryption keys and/or a nonce associated with the watermarked encrypted biometric image to a cloud system, e.g., for storage and audit.

Some innovative aspects of the subject matter described in this disclosure may be implemented in one or more methods. Some disclosed methods may involve obtaining, via a biometric sensor system of a first device, a biometric image from a user. Some method may involve producing, via a control system, a watermarked encrypted biometric image by either: (i) encrypting the biometric image to produce an encrypted biometric image and adding a watermark to the encrypted biometric image, or (ii) adding the watermark to the biometric image to produce a watermarked biometric image and encrypting the watermarked biometric image. Some methods may involve providing the watermarked encrypted biometric image to a second device for authentication. According to some examples, the second device may be a payment terminal, an access control terminal or a server.

The watermark may be visible or invisible, depending on the implementation. In some examples, the watermark may vary over time. The watermark may cover an entire area of the encrypted biometric image or a partial area of the encrypted biometric image. In some examples, the watermark may encode at least one of a timestamp, an apparatus identifier, a payment terminal identifier, a session identifier, a nonce, or a value associated with a pairing between the apparatus and the payment terminal.

Some methods may involve obtaining a plurality of biometric images from the user. Some methods may involve spreading the watermark across the plurality of biometric images. Some methods may involve including, with one biometric image of the plurality of biometric images, a hash of a subsequent biometric image of the plurality of biometric images.

In some examples, the watermark may be, or may include, a personalized watermark. Some methods may involve receiving the personalized watermark from another device, such as the user’s mobile device.

Some methods may involve providing at least one of encryption keys or a nonce associated with the watermarked encrypted biometric image to a cloud system, e.g., for storage and audit.

In some instances, the second device may be a payment terminal and the authentication may be for a transaction. Some methods may involve evaluating, via the payment terminal or a cloud system, the watermark based on one or more keys. Some methods may involve denying the transaction based on detecting tampering of the watermark.

Some methods may involve performing an anti-spoof check and/or a liveness check. The type of anti-spoof check or liveness check may depend on the type of biometric image(s). For example, if a biometric image is a palm image, an anti-spoof check and/or a liveness check may involve obtaining infrared images from one or more cameras and performing a palm vein pattern analysis, analyzing the heat distribution of the hand, detecting a pulse, etc.

Some or all of the operations, functions or methods described herein may be performed by one or more devices according to instructions (such as software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented in one or more non-transitory media having software stored thereon. For example, the software may include instructions for controlling one or more devices to perform some or all of the disclosed methods.

Some innovative aspects of the subject matter described in this disclosure may be implemented in a system that includes a first device and a second device. The first device may include a biometric sensor system. The second device may be a payment terminal, an access control terminal or a server.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

Non-limiting and non-exhaustive examples are described herein with reference to the following figures.

FIG. 1 is a block diagram that presents example components of an apparatus according to some disclosed implementations.

FIG. 2A shows an example of a payment system that includes a biometric module and a payment terminal.

FIG. 2B shows another example of a payment system that includes a biometric module and a payment terminal.

FIG. 2C shows an example of a payment system that includes a biometric module and a payment terminal.

FIGS. 3A and 3B show additional examples of a systems that include a biometric module.

FIG. 4 shows an example of a payment terminal that includes integrated biometric functionality.

FIGS. 5A and 5B show additional examples of systems configured for implementing aspects of the present disclosure.

FIGS. 6A, 6B and 6C show examples of watermarking and hash chaining.

FIGS. 7A, 7B and 7C illustrate methods of obtaining and using a personalized watermark from a user’s device.

FIG. 8 is a flow diagram that presents example blocks of operations according to some disclosed methods.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system that includes a biometric system as disclosed herein. In addition, it is contemplated that the described implementations may be included in or associated with a variety of electronic devices such as, but not limited to: mobile telephones, multimedia Internet enabled cellular telephones, mobile television receivers, wireless devices, smartphones, smart cards, wearable devices such as bracelets, armbands, wristbands, rings, headbands, head-mounted devices, including but not limited to XR headsets and XR eyeglass frames, patches, etc., Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (such as e-readers), mobile health devices, computer monitors, automobile components, including but not limited to automobile displays (such as odometer and speedometer displays, etc.), cockpit controls or displays, camera view displays (such as the display of a rear view camera in a vehicle), electronic photographs, electronic billboards or signs, projectors, architectural structures, microwaves, refrigerators, stereo systems, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also may be used in applications such as, but not limited to, electronic switching devices, radio frequency filters, sensors, accelerometers, gyroscopes, motion-sensing devices, magnetometers, inertial components for consumer electronics, parts of consumer electronics products, steering wheels or other automobile parts, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Biometric retrofit modules could enable biometrics on payment terminals, access systems and other existing infrastructure which require identity verification. Payment terminals normally have long product lifecycles. Adding increased functionality—such as biometrics capabilities—to payment terminals via retrofit modules could provide the advantage of payment terminal upgrade without completely upgrading an existing payment terminal. Accordingly, some people and entities have recently been requesting retrofit solutions.

As used herein, a ‘biometric image’ may refer to data captured by a biometric sensor system that represents at least a portion of a user’s biometric characteristic. For example, a biometric image may be image date captured as a still image or as a sequence of images. Some examples of biometric images include visible or infrared face images, palm images, fingerprint images, infrared images, depth images, or frames thereof, whether raw or pre-processed. In the context of biometric authentication, biometric images are often used to generate corresponding biometric “templates,” which may include biometric attributes as well data indicating the arrangement in space of these biometric attributes. In the context of fingerprint images, the corresponding biometric templates may include fingerprint minutiae (such as fingerprint ridge endings, fingerprint ridge bifurcations, etc.) and data indicating the arrangement in space of the fingerprint minutiae. In the context of facial recognition technology, a biometric template may include one or more “feature vectors,” which are sets of numbers created by a neural network (such as a convolutional neural network (CNN)) rather than simple geometric measurements and feature type descriptors. There have been recent efforts to standardize biometric template formats. This means that a hacker could potentially create biometric templates out of raw biometric images. Hence, there is ongoing research and effort being put into protecting biometric templates.

Accordingly, adding biometrics capabilities to an existing payment terminal via a retrofit module creates various possibilities for security breaches. For example, data from a biometric-capable module connected to an existing payment terminal could be removed and valuable information could be downloaded from the terminal via added malware on the biometric module or on the existing payment terminal. Security attacks could include man-in-the-middle attacks, stolen biometric data, injection attacks, hold-and-replay attacks, etc. In the context of payment terminals, stolen biometrics pose threats in the forms of financial losses to individuals, merchants and institutions, as well as bad publicity for the entities involved.

As used herein, “encrypting” or “encryption” refers to applying one or more cryptographic operations to data to render the data unintelligible to unauthorized parties. For example, the cryptographic operations may include using one or more keys for symmetric or asymmetric encryption of the data and may be applied to all or a portion of the data. As used herein, a “watermark” may refer to information, such as an image, text, a numeric or alphanumeric code, etc., that is embedded in, or associated with, all or part of an instance of digital or analog content. In some disclosed examples, a watermark may be embedded in a biometric image, whether visibly or invisibly, in the image domain or signal domain, and may be usable to authenticate, trace, and/or verify integrity or authenticity of the biometric image. Some disclosed implementations provide a system to encrypt and watermark biometric images close to, or at, the device or system from which the biometric images are obtained. The watermark may have a timestamp. According to some examples, the watermark may be, or may include, a number or an alphanumeric code. In some examples, the watermark may cover an entire image, whereas in other examples the watermark may cover a partial image. According to some examples, the watermark may be spread over a sequence of images, which may be consecutive or non-consecutive images, in order to make it harder to remove the watermark. In some examples, the watermark may change over time. In some such examples, the watermark may be valid only during a particular time interval. Alternatively, or additionally, a watermark may vary over time. In some such examples, the variation may be deterministic or rule-based, whereas in other examples the variation may be random. According to some examples, a watermark may be valid only during a particular session, transaction, or frame. As used herein, the term “transaction” refers to a set of operations or set of messages performed by or sent within a device or between devices, for which authentication or verification is performed. A transaction may involve an exchange or transfer of goods, services or funds between two or more parties. A set of operations and/or a set of messages corresponding to a transfer of funds is one example of what may be referred to herein as a “financial transaction.”

According to some examples, a watermark may be associated with a retrofit biometric module/payment terminal pair. For example, each retrofit biometric module/payment terminal pair may have a different watermark. In some such examples, the watermark may be a serial number or an alphanumeric code associated with the biometric module/payment terminal pair.

In some examples, a control system may be configured to use the watermark as part of an authentication process that is based on a corresponding biometric image. According to some examples, an anti-spoof/liveness engine implemented by a control system may be configured to detect whether a watermark has been tampered with. In some examples, a hash of a (n+1)^{th} image can be stored as part of the n^{th} image payload to form a linked chain. According to some examples, a user may be able to pre-register a watermark with a biometric service provider and to pass that watermark to a payment terminal as a means for multi-factor authentication.

Although most of the present disclosure involves retrofit biometric modules for payment terminals, some disclosed implementations are entirely new payment terminal devices and systems that include biometric authentication capabilities and associated security devices and methods.

Particular implementations of the subject matter described in this disclosure may be implemented to realize one or more of the following potential advantages. In some implementations, an existing, installed payment terminal may be upgraded with a retrofit biometric module that provides biometric authentication capabilities and associated security methods. Some disclosed implementations provide a system to encrypt and watermark biometric images close to, or at, the retrofit biometric module at which the biometric images are obtained. Some disclosed implementations provide the ability to trace the lifecycle of the biometric image though the payment device. Some disclosed implementations provide the ability to verify a transaction during any audits based on stored data, e.g., for review of a payment transaction during refunds/disputes etc., if a merchant stores the activity on premises or in the cloud/on one or more servers.

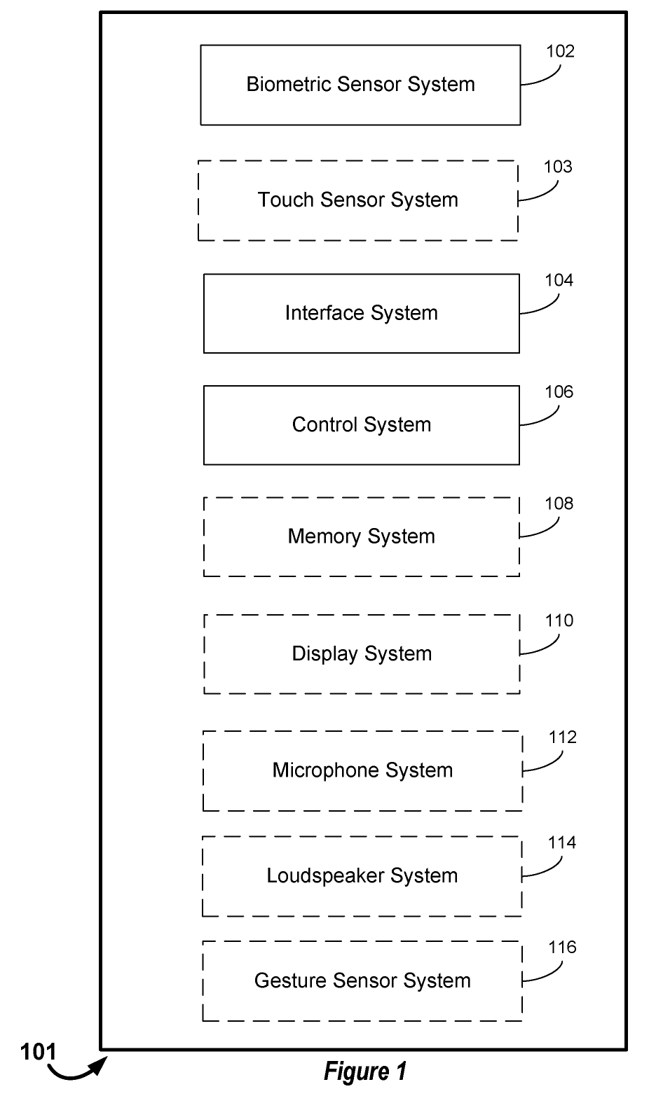

FIG. 1 is a block diagram that presents example components of an apparatus according to some disclosed implementations. In this example, the apparatus 101 includes a biometric sensor system 102, an interface system 104 and a control system 106. According to some examples, the apparatus 101 may be, or may include, what is referred to herein as a “biometric module,” such as a “retrofit biometric module.” In some examples, the apparatus 101 may be a mobile device such as a cellular telephone. In some instances, the apparatus 101 may be, or may include, what is referred to herein as a payment terminal. In some examples, the apparatus 101 may be a payment terminal configured to communicate with a biometric module. In some such examples, the payment terminal may not include a biometric sensor system. However, according to some examples, the apparatus 101 may include both biometric module and payment terminal capabilities. In some examples, the apparatus 101 may be a biometric module configured to communicate with a payment terminal. According to some examples, the apparatus 101 may be mobile device configured to communicate with a biometric module and/or a payment terminal. The numbers, types and arrangements of elements shown in the figures provided herein, including but not limited to FIG. 1, are merely examples. Other examples may include different elements, different arrangements of elements, or combinations thereof. Components shown with dashed outlines in FIG. 1 may be optional. Some implementations may include a memory system 108, a display system 110, a microphone system 112, a loudspeaker system 114, a gesture sensor system 116, or combinations thereof. In other examples, the apparatus 101 may be configured for another type of biometric authentication use case, such as an access control use case (for a vehicle, a room, a building, etc.).

In some examples, the biometric sensor system 102 may include one or more fingerprint sensors, cameras, retinal scanners, one or more other devices configured for obtaining biometric data, or combinations thereof. Accordingly, the biometric sensor system 102 may include one or more cameras, such as a red/green/blue (RGB) camera, a near-infrared (NIR) camera, or a combined RGB/NIR camera. According to some examples, the biometric sensor system 102 is configured for obtaining one or more types of biometric image data from a person. In some examples, the biometric sensor system 102 may be configured for obtaining face images, palm images, fingerprint images, or combinations thereof.

The interface system 104 may be configured to provide communication (which may include wired or wireless communication, electrical communication, radio communication, etc.) between components of the apparatus 101. In some examples, the interface system 104 may be configured to provide communication between the control system 106 and the biometric sensor system 102. According to some implementations in which the apparatus 101 is a biometric module or a payment terminal, the interface system 104 may be configured to provide communication between the biometric module and the payment terminal. According to some implementations in which the apparatus 101 is, or includes, a payment terminal, the interface system 104 may be configured to provide communication between the payment terminal and one or more other devices—such as one or more servers of a financial institution—via a network. According to some implementations in which the apparatus 101 is, or includes, a biometric module, the interface system 104 may be configured to provide communication between the biometric module and one or more other devices—such as one or more servers of a financial institution—via a network. In some examples, the interface system 104 may be configured to provide communication between the apparatus 101 and a human being. In some such examples, the interface system 104 may include one or more user interfaces. In some examples, the user interface(s) may be provided via a touch sensor system, a display system, a camera system, a microphone system, a gesture sensor system, or combinations thereof. The interface system 104 may, in some examples, include one or more network interfaces or one or more external device interfaces. The interface system 104 may include one or more wired interfaces (such as one or more universal serial bus (USB) interfaces or a serial peripheral interface (SPI)), wireless interfaces such as Bluetooth, UWB, WLAN, or cellular connectivity, or combinations thereof.

The control system 106 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. According to some examples, the control system 106 also may include one or more memory devices, such as one or more random access memory (RAM) devices, read-only memory (ROM) devices, etc. According to some examples, the control system 106 may include one or more dedicated components for controlling the biometric sensor system 102.

According to some examples, the control system 106 may be configured to produce a watermarked encrypted biometric image. The control system 106 may be configured to produce the watermarked encrypted biometric image by (i) encrypting the biometric image to produce an encrypted biometric image and adding a watermark to the encrypted biometric image, or (ii) adding a watermark to the biometric image to produce a watermarked biometric image and encrypting the watermarked biometric image. In some examples, the control system 106 may be configured to provide the watermarked encrypted biometric image to a second device, such as a server or a payment terminal, via the interface system 104. In some such examples, the control system 106 may be configured to provide the watermarked encrypted biometric image to the second device for authentication. According to some examples, the second device, or another device, may be configured to perform an authentication process based, at least in part, on the watermarked encrypted biometric image. In some examples, a control system of another device, such as a payment terminal control system or a server control system, may be configured to authenticate a transaction via the watermarked encrypted biometric image. According to some examples, the transaction may be a financial transaction. However, in other examples, the authentication process may be an access control authentication process, e.g., an authentication process related to controlling access to a building, a room, a device, an online account, etc. In some such examples, the authentication process may involve controlling access to a digital media, e.g., access to a content streaming service.

In some instances, the control system 106 of FIG. 1 may be implemented entirely within a single device. In other instances, functionality of the control system 106 may be distributed across multiple devices. For example, some control system functions may be performed by a biometric module, while other functions may be performed by a payment terminal, a cloud system, or a combination thereof. The distribution of control system functionality across devices may depend on the architecture, connectivity, and capabilities of the devices in the system.

In some examples, the control system 106 may be configured to add a watermark that is visible or invisible. A visible watermark may be perceptible to a human observer, while an invisible watermark may be imperceptible to a human observer, but detectable using appropriate software or hardware. The control system 106 may be configured to add a watermark that covers an entire area of the biometric image or a partial area of the biometric image.

In some examples, the control system 106 may be configured to buffer a plurality of biometric images obtained by the biometric sensor system 102 and include, with a preceding biometric image of the plurality of biometric images, a hash of a subsequent biometric image of the plurality of biometric images. The buffering may occur in a memory of the control system 106 and/or in the memory system 108. This hash chaining approach can create a chain of trust that may be used to verify the integrity and sequence of the biometric images. Any appropriate data, such as watermarks, encryption keys, nonces, hashes, and other data may be stored in a memory of the control system 106 and/or in the memory system 108.

In some examples, the control system 106 may be configured to spread a watermark across a plurality of biometric images. Rather than including a complete watermark in each biometric image, the control system 106 may divide the watermark into portions and distribute the portions across two or more biometric images. The complete watermark may only be obtained when watermark portions from two or more biometric images in the sequence are combined.

In some examples, the control system 106 may be configured to encode in the watermark at least one of a timestamp, a personal device identifier, a biometric module identifier, a payment terminal identifier, a session identifier, a nonce, or a value associated with a pairing between the biometric module and the payment terminal. The timestamp may indicate when the biometric image was captured. The biometric module identifier may uniquely identify the biometric module. The payment terminal identifier may uniquely identify the payment terminal. The personal device identifier may uniquely identify a personal device of a user, such as a mobile device that is involved in a payment transaction. In some instances, personal device identifier may be encoded in a personalized watermark that is provided by the personal device, e.g., provided to a biometric module and/or to a payment terminal. The session identifier may uniquely identify the current transaction session. The nonce may be a random or pseudo-random value used to prevent replay attacks. The pairing value may be associated with a specific pairing between the biometric module and the payment terminal.

In some examples, the control system 106 may be configured to receive a personalized watermark from a user mobile device and add the personalized watermark to the biometric image. The personalized watermark may correspond with a particular user of the mobile device, such as a user of a cellular telephone. The personalized watermark may be transferred from the mobile device to the biometric module via Bluetooth, UWB (Ultra-Wideband), or another wireless communication protocol. The personalized watermark may be pre-registered with a biometric service provider during an enrollment or registration phase.

In some examples, the control system 106 may be configured to provide at least one of encryption keys or a nonce associated with the watermarked encrypted biometric image to a cloud system, e.g., for storage and audit. This process may allow the biometric image to be tracked from the device to final recognition during an audit, and may allow for review of payment transactions during refunds or disputes.

In some examples, the control system 106 may be configured to attach a hash message authentication code (HMAC) to the watermarked encrypted biometric image. The HMAC may be used to verify the integrity of the watermarked encrypted biometric image and to authenticate the source of the image.

In some examples, the control system 106 may be configured to perform an anti-spoof check or a liveness check. The anti-spoof check or liveness check may include detecting a prior watermark in the biometric image that is indicative of a spoof. For example, if an attacker photographs a watermarked preview image displayed on a terminal and presents that photograph to the biometric sensor system 102, the control system 106 may detect the prior watermark in the captured image and determine that the image is a spoof rather than a live biometric capture.

In some examples, the control system 106 may be configured to vary the watermark over time. The watermark may change periodically, similar to how encryption keys are rotated. Varying the watermark over time may make it more difficult for an attacker to predict or forge watermarks.

As noted above, the control system 106 may have its own memory, and the memory system 108 may provide additional memory for storing biometric images, encryption keys, watermarks, and other data. In some examples, control system 106 or the memory system 108 may be configured to buffer a plurality of biometric images. In some examples, the memory system 108 may include one or more memory devices, such as one or more RAM devices, ROM devices, etc. In some implementations, the memory system 108 may include one or more non-transitory computer-readable media, storage media or storage media. Computer-readable media include both computer storage media and communication media including any medium that may be enabled to transfer a computer program from one place to another. Storage media may be any available media that may be accessed by a computer. In some examples, the memory system 108 may include one or more non-transitory media. By way of example, and not limitation, non-transitory media may include RAM, ROM, electrically erasable programmable read-only memory (EEPROM), compact disc ROM (CD-ROM) or other optical disk storage, magnetic disk storage or other magnetic storage devices, or any other medium that may be used to store desired program code in the form of instructions or data structures and that may be accessed by a computer.

In some examples, the apparatus 101 may include a display system 110. In some such examples, the display system 110 may be, or may include, a light-emitting diode (LED) display, such as a microLED display, an organic LED (OLED) display, or combinations thereof.

In some implementations, the apparatus 101 may include a microphone system 112. The microphone system 112 may include one or more microphones, one or more types of microphones, or combinations thereof.

According to some implementations, the apparatus 101 may include a loudspeaker system 114. The loudspeaker system 114 may include one or more loudspeakers, one or more types of loudspeakers, or combinations thereof.

In some implementations, the apparatus 101 may include a gesture sensor system 116. The gesture sensor system 116 may be, or may include, an ultrasonic gesture sensor system, an optical gesture sensor system or any other suitable type of gesture sensor system.

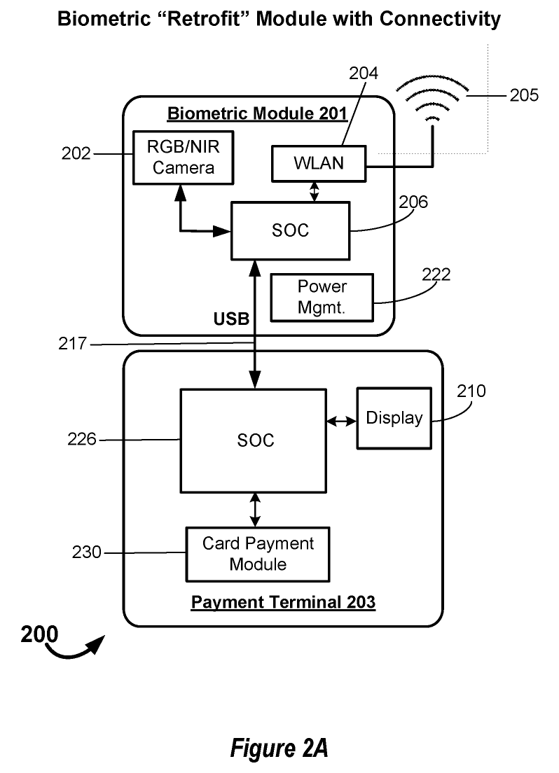

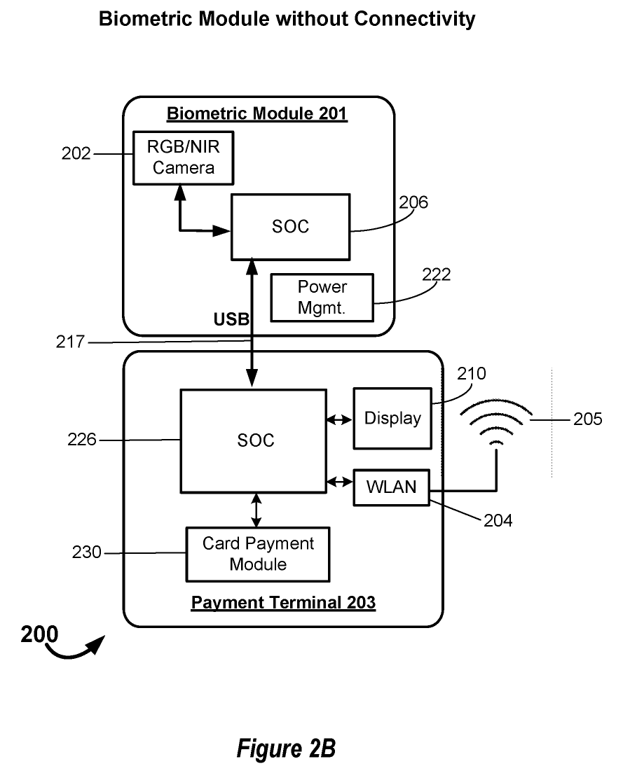

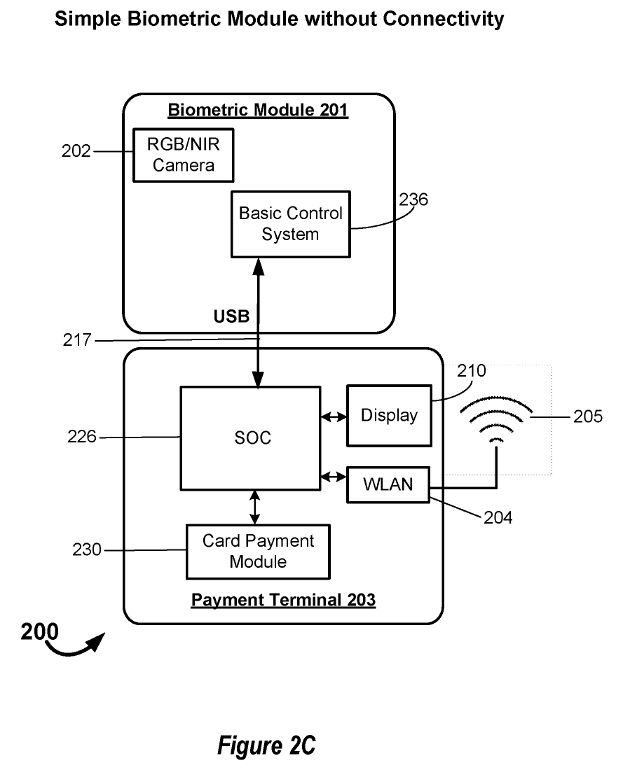

FIG. 2A shows an example of a payment system that includes a biometric module and a payment terminal. Here, the payment system 200 includes a biometric module 210 and a payment terminal 203, which may be instances of the apparatus 101 of FIG. 1. The numbers, types and arrangements of elements shown in the figures provided herein, including but not limited to FIG. 2A, are merely examples. Other examples may include different elements, different arrangements of elements, or combinations thereof.

According to this example, the biometric module 201 include a camera system 202, a wireless interface system 204 (which is a wireless local area network (WLAN) system in this example) having an antenna 205, a control system 206, and power management circuitry 222. In this example, the control system 206 is implemented as a system-on-a-chip (SOC). The control system 206 may be referred to herein as a “biometric module control system.” In some examples, the camera system 202 may be a combined RGB and NIR camera for capturing both visible light images and near-infrared images, the latter of which may be useful for vein pattern scanning in palm biometrics. In this example, the wireless interface system 204 is configured for wireless connectivity to a cloud system (not shown in FIG. 2A). Because the biometric module 201 has wireless connectivity in the implementation shown in FIG. 2A, this configuration allows the biometric module 201 to communicate directly with a cloud system without relying on another device (such as the payment terminal 203) for connectivity.

In this example, the biometric module 201 does not include a display. However, in some alternative implementations, the biometric module 201 may include a display.

With continued reference to FIG. 2A, in this example the payment terminal 203 includes a display 210, a control system 226, and a card payment module 230. The control system 226 may be referred to herein as a “payment terminal control system.” The display 210 may be used to present graphical user interfaces and/or text for user guidance, according to instructions from the control system 226. The card payment module 230 may be configured to process card-based payments. The payment terminal 203 may work within a credit card-based system that is implemented, in part, via communications with a cloud-based service. In this example, the biometric module 201 is configured communicate with the payment terminal 203 via a wired interface 217, which is a universal serial bus (USB) interface in this example.

FIG. 2B shows another example of a payment system that includes a biometric module and a payment terminal. The biometric module 210 and the payment terminal 203 may be instances of the apparatus 101 of FIG. 1. According to this example, the payment system 200 includes a biometric module 201 without wireless connectivity. In this architecture, the payment terminal 203 includes wireless interface system 204 and antenna 205 for wireless connectivity to a cloud system (not shown). In this example, the biometric module 201 includes a camera system 202, a control system 206, and power management circuitry 222, but relies on the payment terminal 203 for cloud connectivity. This architecture may require the biometric module 201 to send biometric data to the payment terminal 203, which may then forward corresponding data to the cloud. This configuration may introduce additional security considerations, e.g., at the interface between the biometric module 201 and the payment terminal 203.

In the examples shown in FIGS. 2A and 2B, the control system 206 of the biometric module 201 may be configured to perform at least some of the encryption-related and watermark-related functionality disclosed herein. For example, the control system 206 may be configured to produce a watermarked encrypted biometric image by: (i) encrypting the biometric image to produce an encrypted biometric image and adding a watermark to the encrypted biometric image, or (ii) adding a watermark to the biometric image to produce a watermarked biometric image and encrypting the watermarked biometric image. The watermark may encode a timestamp, a biometric module identifier, a payment terminal identifier, a session identifier, a nonce, a value associated with a pairing between the biometric module and the payment terminal, or combinations thereof. The control system 206 may be configured to receive a personalized watermark from a user mobile device and add the personalized watermark to the biometric image. The control system 206 may be configured to provide the watermarked encrypted biometric image to the payment terminal 203 via the interface 217, e.g., for authentication of a transaction.

The control system 206 may be configured to obtain a plurality of biometric images from a user via the camera 202. The control system 206 may be configured to buffer the plurality of biometric images and include, with a preceding biometric image of the plurality of biometric images, a hash of a subsequent biometric image of the plurality of biometric images. The control system 206 may be configured to spread a watermark across a plurality of biometric images.

FIG. 2C shows an example of a payment system that includes a biometric module and a payment terminal. Here, the payment system 200 includes a biometric module 210 and a payment terminal 203, which may be instances of the apparatus 101 of FIG. 1. In this example, the biometric module 201 includes a basic control system 236 having minimal functionality. In this architecture, the biometric module 201 is a minimal, potentially inexpensive, retrofit module that includes a camera system 202 and the basic control system 236. The basic control system 236 may perform basic image processing such as adjusting brightness and auto exposure, and may transform image data from the camera 202 into a format that is usable by the control system 226 of the payment terminal 203. For example, to send video over USB, the data may need to be in UVC format, so the basic control system 236 may include a small chip for this purpose. The payment terminal 203 includes wireless interface system 204, antenna 205, display 210, control system 226, and card payment module 230.

In examples such as that shown in FIG. 2C, the control system 226 may be configured to perform most or all of the encrypting functionality, the watermarking functionality, the hashing functionality, etc., that may in other implementations be performed by control system 206.

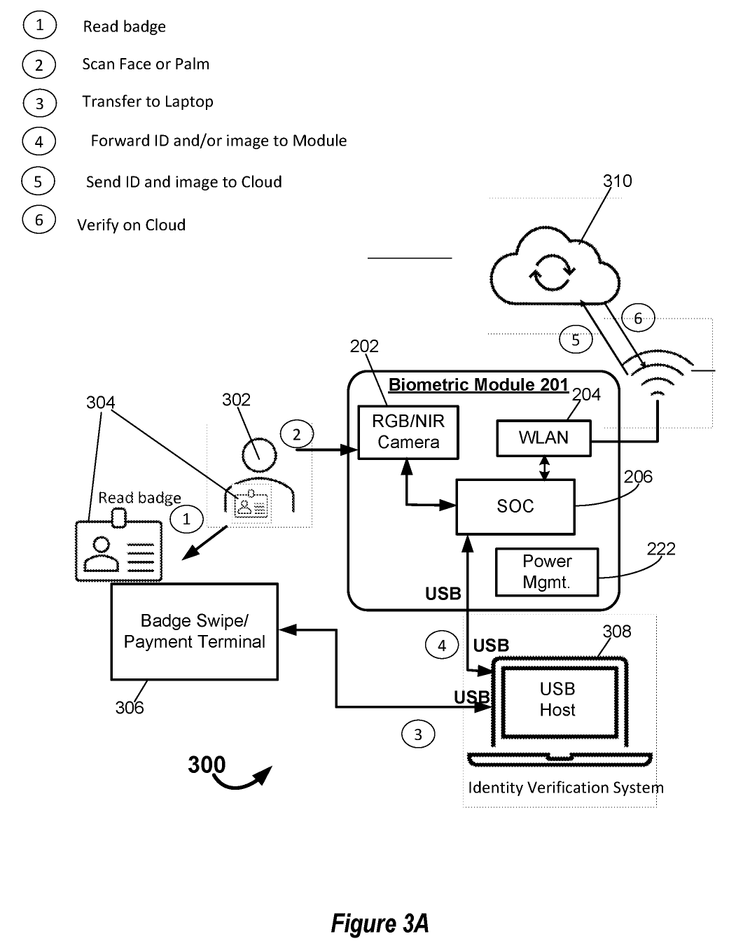

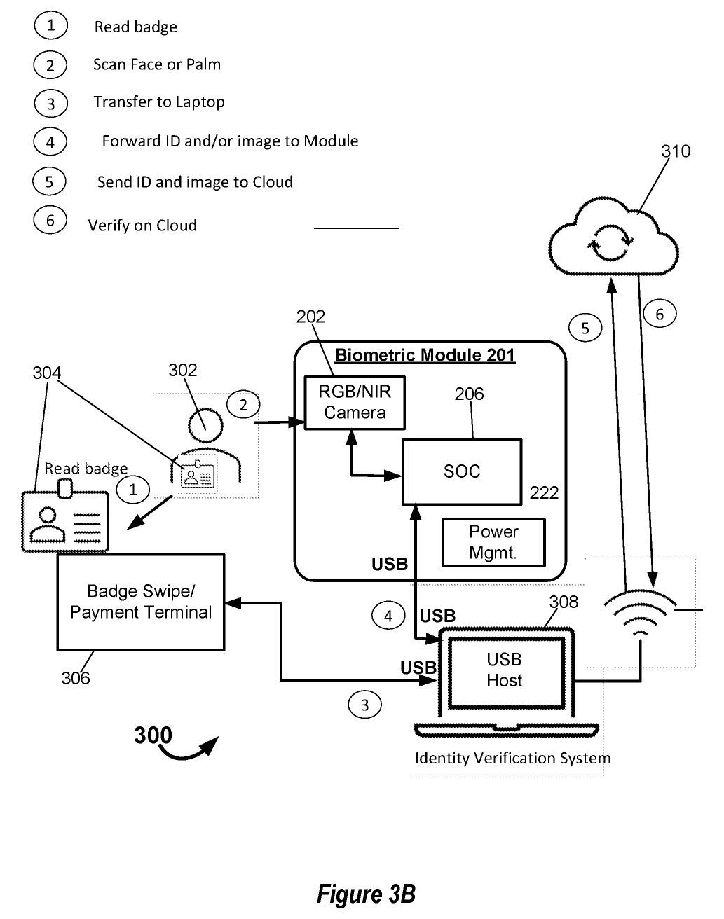

FIGS. 3A and 3B show additional examples of a systems that include a biometric module. In FIGS. 3A and 3B, the biometric module 210, the badge swipe/payment terminal 306 and the USB host 308 of system 300 may be instances of the apparatus 101 of FIG. 1. The USB host 308,which is a laptop in the examples shown in FIGS. 3A and 3B, functions as a bridge between the biometric module 210 and the badge swipe/payment terminal 306. As with the other disclosed implementations, the numbers, types and arrangements of elements shown in FIGS. 3A and 3B are merely examples. Other examples may include different elements, different arrangements of elements, or combinations thereof. In some alternative examples, the USB host 308 may provide server functionality, e.g., by hosting a database of biometric templates of a set of users (e.g., all students in a school, all authorized employees of a business, etc.), keeping the templates local on the USB host 308. In some such alternative examples, there may be no need for a connection to the cloud system 310. In other alternative examples, the badge swipe/payment terminal 306 may be configured for USB On-The-Go (OTG) functionality. USB-OTG is a specification allowing devices (e.g., mobile devices such as smartphones, tablets, etc.) to act as a USB host, directly connecting to peripherals such as flash drives, mice, keyboards, or cameras without requiring another host device. In some such alternative examples, there may be no need for the USB host 308.

According to the examples shown in FIGS. 3A and 3B, a user 304 may present a badge 302 to the badge swipe/payment terminal 306. The badge 302 may be an ID card, such as a government-issued card (such as a Social Security card or another card used to obtain financial benefits) an employee badge, etc., that provides user identification information to the system 300. The user identification information may, for example, reduce the search space for biometric matching (e.g., via the cloud system 310).

In the architecture of FIG. 3A, the biometric module 201 has wireless connectivity with the cloud system 310, which may include one or more remote servers, one or more remote data storage devices, etc. In the example of FIG. 3A, the biometric module 201 includes a camera system 202, wireless interface system 204, antenna 205, control system 206, and power management circuitry 222.

According to some examples, the system 300 may operate according to a sequence of steps. In step 1, the badge 302 may be read by the badge swipe/payment terminal 306. In step 2, the user's face or palm may be scanned by the camera system 202 of the biometric module 201 to produces one or more biometric images. In step 3, data may be transferred to the USB host 308. In step 4, the ID and the biometric image(s) may be forwarded from the USB host 308 to the biometric module 201. In some examples, the control system 206 may be configured to produce each of the one or more watermarked encrypted biometric images by (i) encrypting the biometric image to produce an encrypted biometric image and adding a watermark to the encrypted biometric image, or (ii) adding a watermark to the biometric image to produce a watermarked biometric image and encrypting the watermarked biometric image.

In step 5, the ID and the one or more watermarked encrypted biometric images may be sent from the biometric module 201 to the cloud system 310. In step 6, verification may be performed via the cloud system 310 and a verification result may be provided by the cloud system 310 to the USB host 308. The cloud system 310 may be a biometric service provider that authenticates the user's identity and then repackages the information with credit card data for payment processing through existing payment networks.

In the example shown in FIG. 3B, the system 300 includes a biometric module 201 without wireless connectivity. In this architecture, the biometric module 201 includes a camera system 202, an antenna 205, a control system 206, and power management circuitry 222, but does not include WLAN. According to the example shown in FIG. 3B, the USB host 308 provides wireless connectivity with the cloud system 310.

The sequence of steps that may be performed with the system of FIG. 3B is similar to the sequence of steps that may be performed with the system of FIG. 3A, except that in the example of FIG. 3B the biometric module 201 relies on the USB host 308 for cloud connectivity. The biometric module 201 of FIG. 3B may be less expensive than the biometric module 201 of FIG. 3A, but the architecture of FIG. 3B may introduce additional security issues.

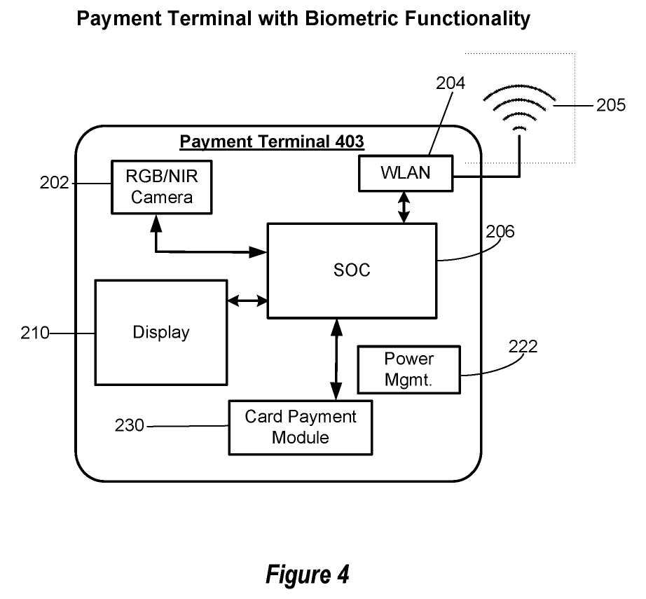

FIG. 4 shows an example of a payment terminal that includes integrated biometric functionality. In this example, the payment terminal 403 includes a camera system 202, wireless interface system 204, antenna 205, control system 206, display 210, power management circuitry 222, and card payment module 230. The architecture of FIG. 4 represents a single integrated module where the biometric capture and payment processing are combined in one device, rather than using a separate retrofit biometric module. Implementations such as that shown in FIG. 4 are advantageous because they provide relatively fewer opportunities for hackers to intercept biometric information than systems having separate biometric modules and payment terminals. However, implementations such as that shown in FIG. 4 are more complex and potentially much more expensive to implement than systems in which a biometric module is added to an existing payment terminal.

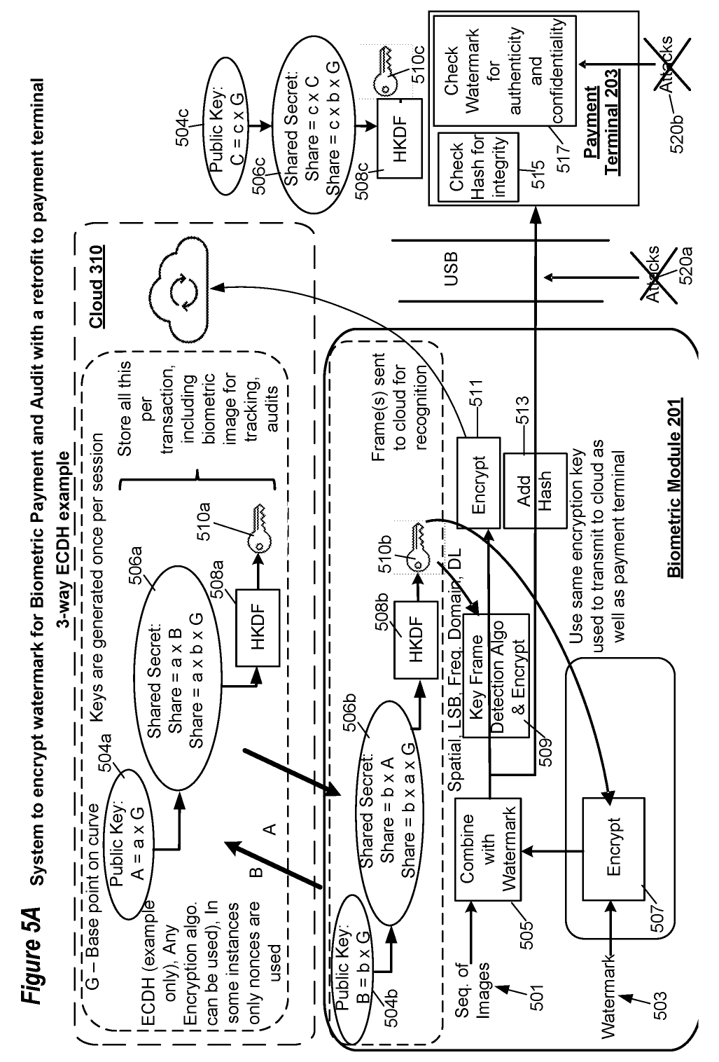

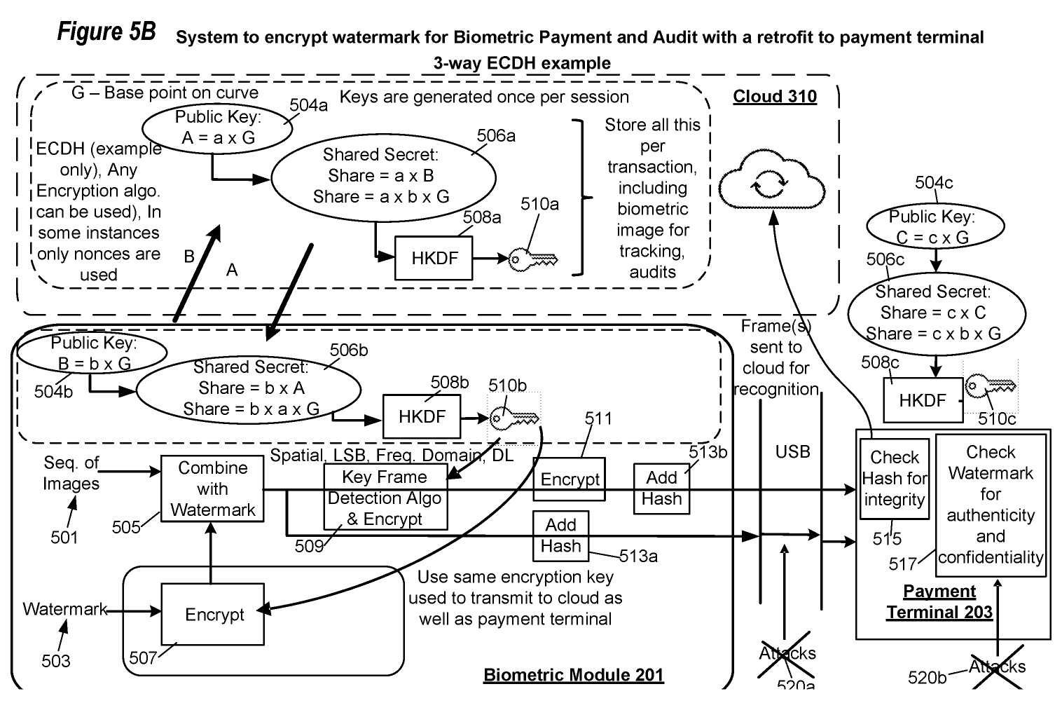

FIGS. 5A and 5B show additional examples of systems configured for implementing aspects of the present disclosure. In FIGS. 5A and 5B, the systems include a biometric module 201, a payment terminal 203 and a cloud system 310. The watermark combination module 505, watermark encryption module 507, key frame detection and encryption module 509 and hashing module(s) 513 of the biometric module 201 are implemented by an instance of the biometric module control system 206. Similarly, the hash integrity check module 515 and the watermark authenticity check module 517 of the payment terminal 203 are implemented by an instance of the payment terminal control system 226. As with the other disclosed implementations, the numbers, types and arrangements of elements shown in FIGS. 5A and 5B are merely examples. Other examples may include different elements, different arrangements of elements, or combinations thereof. For example, the system in FIGS. 5A and 5B is shown implementing a 3-way Elliptic Curve Diffie-Hellman (ECDH) encryption scheme. ECDH is an anonymous key agreement protocol that allows two parties to establish a shared secret key over an insecure channel, using elliptic curve cryptography (ECC). ECDH can provide high security with relatively smaller key sizes, as compared to some other cryptographic methods. However, alternative examples may involve implementing other cryptographic methods, including but not limited to those involving the Triple Diffie-Hellman (3DH) protocol, the Extended Triple Diffie-Hellman (X3DH) protocol, the Elliptic Curve Menezes-Qu-Vanstone (ECMQV) protocol, etc.

In the example shown in FIG. 5A, an encryption and hash chain security flow is illustrated for an architecture in which the biometric module 201 has wireless connectivity with the cloud system 310. Here, the watermark combination module 505 is configured to receive a sequence of biometric images 501, which may be obtained from a camera of the biometric module 201. In this example, the watermark encryption module 507 is configured to receive watermarks 503 and to encrypt the watermarks 503 according to an encryption key 510b derived by the HKDF module 508b. According to this example, the watermark combination module 505 is configured to add the encrypted watermarks from the watermark encryption module 507 to the biometric images 501, to produce watermarked images.

With continued reference to FIG. 5A, the key frame detection and encryption module 509 is configured to receive the sequence of watermarked images from the watermark combination module 505 and outputs one or more encrypted, watermarked frames 511. In the example shown in FIG. 5A, the encrypted, watermarked frames 511 are sent by the biometric module 201 to the cloud system 310. According to this example, the hashing module 513 is configured to receive a sequence of watermarked images from the watermark combination module 505, add a hash, and provide one or more hashed, watermarked images to the payment terminal 203. The payment terminal 203 includes a hash integrity check module 515 configured to perform a hash verification process on the one or more hashed, watermarked images and a watermark authenticity check module 517 configured to check the watermarks one or more hashed, watermarked images for authenticity.

With continued reference to FIG. 5A, in this example the system uses a 3-way ECDH key exchange scheme involving the biometric module 201, the payment terminal 203, and the cloud system 310. In this example, public keys 504a, 504b, and 504c may be exchanged between the devices. Shared secrets 506a, 506b, and 506c may be derived between pairs of parties. HKDF (HMAC-based Key Derivation Function) modules 508a, 508b, and 508c may derive encryption keys 510a, 510b, and 510c, respectively, from the shared secrets. In this example, the encryption key 510a is derived by the cloud system 310.

Here, the encryption key 510b is derived by the biometric module 201. In this example, the encryption key 510b may be used by the watermark encryption module 507 to encrypt watermarks. Here, the encryption key 510b is used by the key frame detection and encryption module 509 to encrypt watermarked frames of biometric images. Some examples may involve combining a watermark with a key frame and then encrypting, whereas other examples may involve encrypting the watermark, adding the encrypted watermark to the key frame and then encrypting the combination.

According to this example, the encryption key 510c is derived by the payment terminal 203. The encryption key 510c may be used for decrypting encrypted images and/or watermarks received from the biometric module 201.

With continued reference to FIG. 5A, potential attack vectors are illustrated as attacks 520a and attacks 520b. Attacks 520a may represent attack vectors on the channel between the biometric module 201 and the payment terminal 203, such as man-in-the-middle attacks, injection attacks, or hold and replay attacks. Attacks 520b may represent attack vectors on the channel between the payment terminal 203 and the cloud system 310. The watermarking and encryption techniques described herein may help protect against these attacks.

Referring now to FIG. 5B, an encryption and hash chain security flow is illustrated for architecture cases where the biometric module 201 lacks wireless connectivity with the cloud system 310. In this architecture, the biometric module 201 cannot send encrypted, watermarked frames 511 directly to the cloud system 310. Instead, the payment terminal 203 sends one or more hashed, encrypted watermarked images to the cloud system 310 after checking the hash for integrity with the hash integrity check module 515. Other than this difference, the overall flow is substantially the same as that of FIG. 5A.

However, another difference between the systems of FIGS. 5A and 5B is that in the example of FIG. 5B, the system includes two hashing modules 513a and 513b. In this example, hashing module 513a is configured to receive a sequence of watermarked images from the watermark combination module 505 and add a hash. Hashing module 513b is configured to add a hash to the one or more encrypted, watermarked frames 511 from the key frame detection and encryption module 509 and to provide one or more hashed, encrypted watermarked images to the payment terminal 203. The payment terminal 203 includes the hash integrity check module 515 and the watermark authenticity check module 517. In some examples if the hash integrity check module 515 and the watermark authenticity check module 517 determine that no manipulations have occurred to the hashed, encrypted watermarked images received from the biometric module 210, the payment terminal 203 may not decrypt the hashed, encrypted watermarked images. Instead, the payment terminal 203 may package the hashed, encrypted watermarked images corresponding payment data, etc., to construct a complete payment transaction payload, and may submit the complete payment transaction payload to the cloud 310.

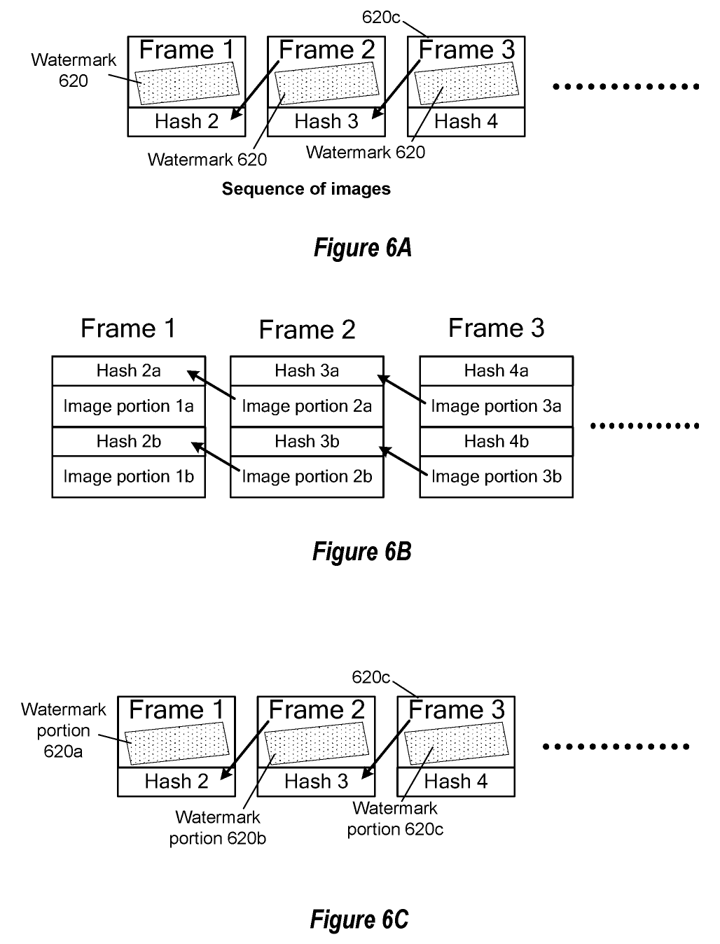

FIGS. 6A, 6B and 6C show examples of watermarking and hash chaining. Referring first to FIG. 6A, a hash chaining approach with a complete watermark in each frame is illustrated. In this approach, each frame in a sequence of biometric images contains a hash derived from the next frame in the sequence. For example, Frame 1 contains hash #2, which is based on the image content of Frame 2. Frame 2 contains hash #3, which is based on the image content of Frame 3. Frame 3 contains hash #4, which is based on the image content of Frame 4. This sequence may continue for any number of frames. In this example, each frame contains the same, complete watermark 620. The watermark 620 may cover the entire area of each image or a partial area of each image.

With continued reference to FIG. 6A, the hash chaining approach creates a chain of trust similar to boot chain verification, where the hash of the next software image is stored as part of the current image. By including the hash of the subsequent frame with the current frame, the system may verify that the sequence of frames has not been tampered with, that no frames have been injected or replaced, and that the frames are being received in the correct order. If an attacker attempts a hold and replay attack by substituting a previous frame, the hash of the substituted frame would not match the actual subsequent frame, and the tampering could be detected.

Referring to FIG. 6B, a portion-based hash chaining approach is illustrated. In this approach, each frame contains multiple hashes derived from corresponding portions of the next frame in the sequence. For example, Frame 1 contains hash 2a, which is based on image portion 2a of Frame 2. Here, Frame 1 also contains hash 2b, which is based on image portion 2b of Frame 2. Frame 2 contains hash 3a, which is based on image portion 3a of Frame 3, and hash 3b, which is based on image portion 3b of Frame 3. This sequence may continue for any number of frames and any number of image portions.

With continued reference to FIG. 6B, the portion-based hash chaining approach provides finer-grained integrity verification by linking specific portions of each frame to corresponding portions of the next frame. This may make it more difficult for an attacker to tamper with or substitute images, since the attacker would need to match multiple portion-based hashes rather than a single whole-image hash. Watermarks are not shown in FIG. 6B for clarity, but the portion-based hash chaining approach of FIG. 6B may be combined with any convenient watermarking methodology, including the complete watermark approach of FIG. 6A or the spread watermark approach of FIG. 6C.

Referring to FIG. 6C, a hash chaining approach with a watermark spread across multiple frames is illustrated. In this approach, each frame contains a hash derived from the next frame in the sequence, as in the method indicated in FIG. 6A. However, instead of having a complete watermark in each frame, the watermark is divided into portions that are distributed across multiple frames. For example, Frame 1 contains watermark portion 620a, Frame 2 contains watermark portion 620b, and Frame 3 contains watermark portion 620c. The watermark portions 620a, 620b, and 620c together form a complete watermark. The number of watermark portions N may be any number between two and a larger number, such as 3, 4, 5, 6, 7, 8, 9, 10, etc.

With continued reference to FIG. 6C, the complete watermark is only obtained when all N frames in the sequence are combined. This makes it harder for an attacker to remove or forge the watermark, since they would need access to the entire sequence of N frames including a partial watermark to obtain or manipulate the complete watermark. Each watermark portion may cover the entire area of its respective frame or a partial area of its respective frame, depending on the particular implementation. The spatial coverage of the watermark within a frame (entire area vs. partial area) is independent of the distribution of the watermark across frames (complete watermark per frame vs. spread watermark).

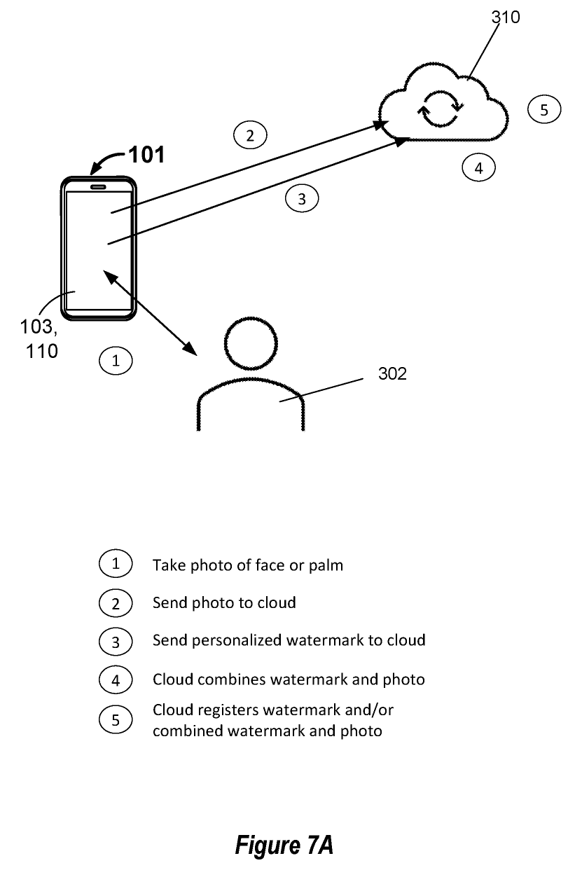

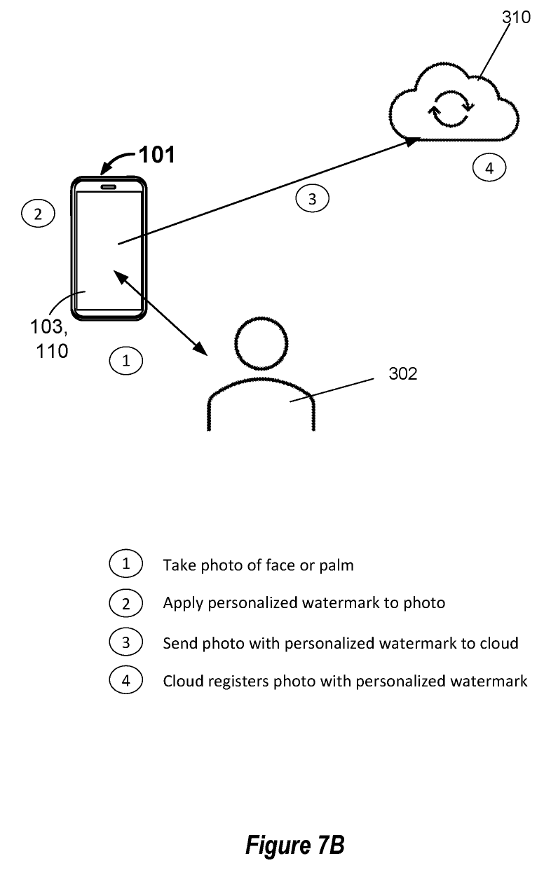

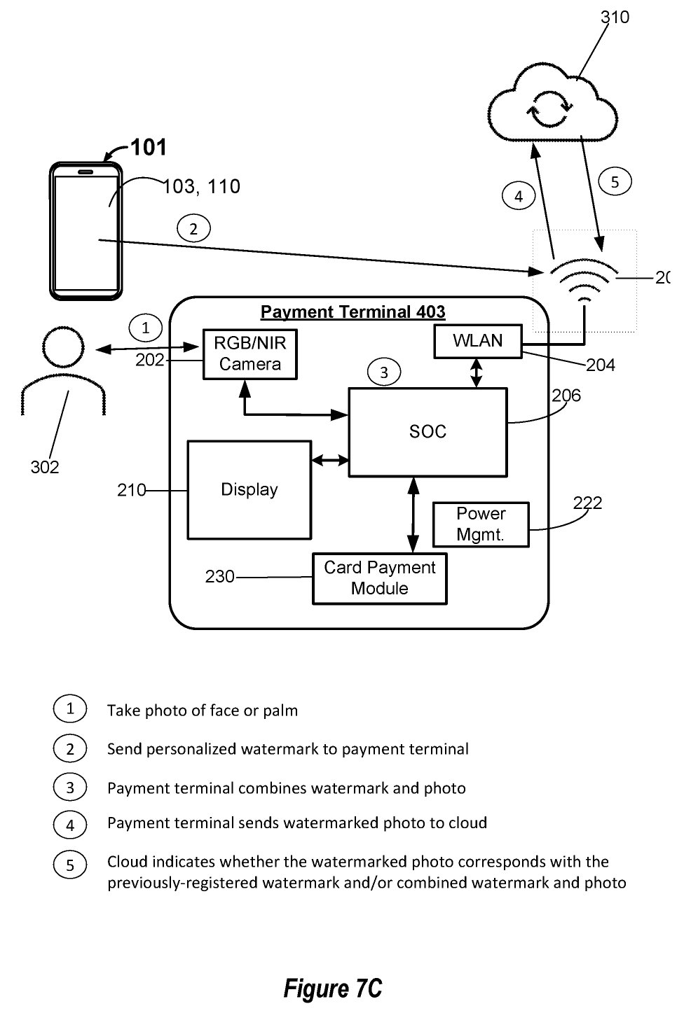

FIGS. 7A, 7B and 7C illustrate methods of obtaining and using a personalized watermark from a user’s device. Referring first to FIG. 7A, a personalized watermark registration process is illustrated in which a cloud system 310 combines a watermark and a photo received separately from a user's mobile device 101, which is an instance of the apparatus 101 of FIG. 1. According to this example, mobile device 101 is a cellular telephone. In step 1, the user takes a photo of face or palm using one or more cameras of the mobile device, which may be part of the biometric sensor system 102 shown in FIG. 1. The photo is an instance of a “biometric image” as that phrase is used herein. In step 2 of FIG. 7A, the user sends the photo to the cloud system 310.

Although not shown as a separate step in FIGS. 7A–7C, the illustrated processes also may involve generating a personalized watermark. Details regarding the personalized watermark may, in some instances, be selected by the user according to one or more GUIs presented on the display system 110 of the mobile device 101. For example, the user may be able to select one or more different attributes of the personalized watermark, such as the time during which the personalized watermark will be valid, the process used to generate the personalized watermark, a system or app for which the personalized watermark will be accessible/used, etc.

In step 3, the user sends a personalized watermark to the cloud system 310 separately from the photo. In step 4, the cloud system 310 combines the watermark and photo. In step 5, the cloud system 310 registers the watermark and/or the combined watermark and photo. This registration process allows the user to pre-register the user’s personalized watermark with a biometric service provider for use during subsequent transactions.

Referring to FIG. 7B, an alternative registration process is illustrated in which a user's mobile device combines a personalized watermark with a photo before sending to a cloud system 310. In step 1, the user takes a photo of face or palm using the mobile device 101. In step 2, the user applies the personalized watermark to the photo on the mobile device 101. In step 3, the user sends, via the mobile device 101, the photo with the personalized watermark to the cloud system 310. In step 4, the cloud system 310 registers the photo with the personalized watermark. The approach of FIG. 7B differs from FIG. 7A in that the combination of the watermark and photo occurs on the user's mobile device 101 rather than in the cloud system 310.

Referring to FIG. 7C, a post-registration transaction process using a previously-registered personalized watermark is illustrated. In step 1, the user takes a photo of face or palm at a payment terminal or biometric module. In step 2, the user sends the previously-registered personalized watermark to the payment terminal, for example via Bluetooth™ or Ultra-wideband (UWB) from the user's mobile device 101. In step 3, the payment terminal combines the watermark and photo. In step 4, the payment terminal sends the watermarked photo to the cloud system 310. In step 5, the cloud system 310 indicates whether the watermarked photo corresponds with the previously-registered watermark and/or combined watermark and photo. This process enables multi-factor authentication by combining the user's biometric with their personalized watermark.

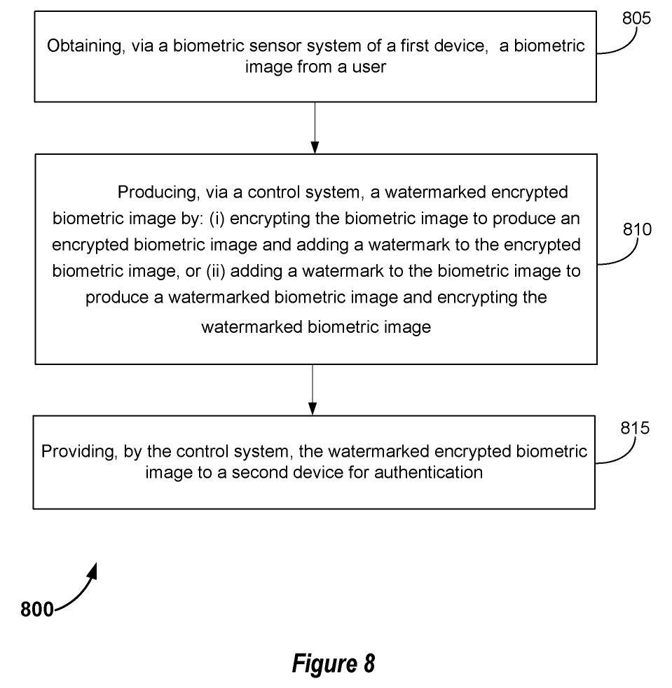

FIG. 8 is a flow diagram that presents example blocks of operations according to some disclosed methods. The blocks of FIG. 8 may, for example, be performed by the apparatus 101 of FIG. 1. According to some examples, at least some aspects of method 800 may be performed by a biometric module control system, whereas in some examples at least some aspects of method 800 may be performed by another control system, such as a payment terminal control system. As with other methods disclosed herein, the methods outlined in FIG. 8 may include more or fewer blocks than indicated. Moreover, the blocks of methods disclosed herein are not necessarily performed in the order indicated. In some implementations, one or more blocks may be performed concurrently.

According to this example, block 805 involves obtaining, via a biometric sensor system of a first device, a biometric image from a user. The biometric sensor system may include one or more cameras, such as an RGB camera, an NIR camera, or a combined RGB/NIR camera. The biometric image may be a face image, a palm image, or a fingerprint image.

In this example, block 810 involves producing, via a control system, a watermarked encrypted biometric image by either (i) encrypting the biometric image to produce an encrypted biometric image and adding a watermark to the encrypted biometric image, or (ii) adding a watermark to the biometric image to produce a watermarked biometric image and encrypting the watermarked biometric image. The order of watermarking and encryption may, in some instances, be selected based on system requirements or security considerations.

According to this example, block 815 involves providing the watermarked encrypted biometric image to a second device for authentication. In some examples, block 815 may involve providing the watermarked encrypted biometric image to a second device for authentication of a transaction. According to some such examples, the transaction may be a financial transaction. For example, the watermarked encrypted biometric image may be provided by a mobile device or by a biometric module to a payment terminal, and the payment terminal may forward the watermarked encrypted biometric image to a cloud system for biometric verification. Alternatively, the mobile device or biometric module may send the watermarked encrypted biometric image directly to the cloud system, e.g., if the biometric module has wireless connectivity. However, in other examples, the authentication process may be an access control authentication process, e.g., an authentication process related to controlling access to a building, a room, a device, an online account, etc. In some such examples, the authentication process may involve controlling access to a digital media, e.g., access to a content streaming service.

In some examples of the method 800, the watermark may be visible whereas in other examples the watermark may be invisible. A visible watermark may be perceptible to a human observer, while an invisible watermark may be imperceptible but detectable by appropriate software or hardware. The watermark may cover an entire area of the encrypted biometric image or a partial area of the encrypted biometric image, depending on the particular implementation.

In some examples of the method 800, a plurality of biometric images may be obtained from the user, and the watermark may be spread across the plurality of biometric images. For example, watermark portions may be distributed across multiple frames as illustrated in FIG. 6C. Additionally or alternatively, a hash of a subsequent biometric image may be included with a preceding biometric image of the plurality of biometric images, as illustrated in FIGS. 6A, 6B, and 6C, .

In some examples of the method 800, the watermark may encode at least one of a timestamp, a first device identifier, such as a mobile device identifier or a biometric module identifier, a second device identifier, such as a payment terminal identifier, a session identifier, a nonce, or a value associated with a pairing between the biometric module and a payment terminal. The timestamp may indicate when the biometric image was captured. The first device identifier may uniquely identify the device that captured the biometric image. The payment terminal identifier may uniquely identify the payment terminal associated with the transaction. The session identifier may uniquely identify the current transaction session. The nonce may be a random or pseudo-random value used to prevent replay attacks. The pairing value may be associated with a pairing between the first device and the second device, e.g., between a mobile device and a server or between a specific biometric module and a specific payment terminal.

In some examples of the method 800, a personalized watermark may be received from a user's mobile device and added to the biometric image. According to some examples, the personalized watermark may be transferred from the mobile device to a biometric module via Bluetooth, UWB, or another wireless communication protocol. The personalized watermark may be pre-registered, e.g., with a biometric service provider, during an enrollment or registration phase. During the registration phase, the user may register their biometric data (e.g., face or palm image) along with their personalized watermark with the biometric service provider. The personalized watermark may then be used during subsequent authentication processes as a form of multi-factor authentication.

In some examples of the method 800, at least one of an encryption key or a nonce associated with the watermarked encrypted biometric image may be provided to a cloud system for storage and audit. This may allow the biometric image to be tracked from the device to final recognition during an audit, and may allow for review of payment transactions during refunds or disputes.

In some examples of the method 800, a hash message authentication code (HMAC) may be attached to the watermarked encrypted biometric image. The HMAC may be used to verify the integrity of the watermarked encrypted biometric image and to authenticate the source of the image.

In some examples of the method 800, the watermark may be evaluated (e.g., based on one or more encryption keys) by the second device (e.g., by a payment terminal or by a server of a cloud system), and the transaction may be denied based on detecting tampering of the watermark. If the second device (or another device) determines that the watermark has been altered, removed, or does not match expected values, the authentication attempt may fail. For example, if a payment terminal or cloud system determines that the watermark has been altered, removed, or does not match expected values, a transaction associated with an authentication attempt may be rejected to prevent fraud.

In some examples of the method 800, an anti-spoof check or a liveness check may be performed. The anti-spoof check or liveness check may include detecting a prior watermark in the biometric image that is indicative of a spoof. For example, if an attacker photographs a watermarked preview image displayed on a terminal and presents that photograph to the biometric sensor, a device or system that is implementing the method 800 may detect the prior watermark in the captured image and determine that the image is a spoof rather than a live biometric capture. An anti-spoof check or a liveness check can provide an additional layer of security against attacks.

In some examples of the method 800, the watermark may vary over time. In some such examples, the watermark may change periodically. This may make it more difficult for an attacker to predict or forge watermarks.

Various combinations and permutations of the features described herein are contemplated. For example, the hash chaining approaches of FIGS. 6A, 6B and 6C, may be combined with any of the watermarking approaches. The whole-image hash chaining of FIG. 6A may be combined with a complete watermark in each frame, a spread watermark across frames, or no watermark. The portion-based hash chaining of FIG. 6B may be combined with a complete watermark in each frame, a spread watermark across frames, or no watermark. The hash chaining with spread watermark of FIG. 6C may use whole-image hashes or portion-based hashes.

In some examples, the watermark may cover the entire area of each image and be complete in each frame. In some examples, the watermark may cover a partial area of each image and be complete in each frame. In some examples, the watermark may cover the entire area of each image and be spread across multiple frames. In some examples, the watermark may cover a partial area of each image and be spread across multiple frames. These combinations provide flexibility in balancing security, image quality, and computational requirements.

In some examples, the biometric module may include various types of biometric sensors. The biometric sensor system may include an RGB camera for visible light imaging, an NIR camera for near-infrared imaging, a combined RGB/NIR camera, an ultrasonic fingerprint sensor, or other biometric sensors. The biometric module may capture face images, palm images (including palm vein patterns), fingerprint images, or other biometric data. In some cases, a high-resolution camera may be used to capture palm images that include visible fingerprint details, allowing for both palm and fingerprint recognition from a single capture.

In some examples, the system may support multiple architectures with different connectivity configurations. In a first architecture (e.g., that of FIGS. 2A or 3A ), the biometric module may have wireless connectivity and may communicate directly with a cloud system. In a second architecture (e.g., that of FIGS. 2B or 3B ), the biometric module may lack wireless connectivity and may rely on the payment terminal for cloud connectivity. In a third architecture (e.g., FIG. 2C), the biometric module may include only a basic control system and may rely on the payment terminal for most processing. In a fourth architecture (e.g., that of FIG. 4), the biometric functionality may be integrated into the payment terminal itself.

In some examples, the system may provide improved security against various types of attacks. The watermarking and encryption techniques may protect against hold and replay attacks, where an attacker intercepts and stores a biometric image for later replay. The techniques may protect against injection attacks, where an attacker injects a stolen biometric image into the system. The techniques may protect against man-in-the-middle attacks, where an attacker intercepts and modifies data in transit. The techniques may protect against spoofing attacks, where an attacker presents a photograph or other reproduction of a biometric to the sensor.

In some examples, the system may provide audit capabilities. By storing encryption keys, nonces, and other data in the cloud, the system may allow for tracking of biometric images from capture to final recognition. This may be useful for reviewing payment transactions during refunds, disputes, or fraud investigations.

Implementation examples are described in the following numbered clauses:
1. An apparatus, including: a biometric sensor system configured to obtain a biometric image from a user; and control system configured to: produce a watermarked encrypted biometric image, wherein:
   (i) to produce the watermarked encrypted biometric image, the control system is configured to encrypt the biometric image to produce an encrypted biometric image and to add a watermark to the encrypted biometric image, or
   (ii) to produce the watermarked encrypted biometric image, the control system is configured to add the watermark to the biometric image to produce a watermarked biometric image and to encrypt the watermarked biometric image; and provide the watermarked encrypted biometric image to a second device for authentication.
2. The apparatus of clause 1, where the watermark is visible or invisible, and where the watermark covers an entire area of the encrypted biometric image or a partial area of the encrypted biometric image.
3. The apparatus of clause 1 or clause 2, where the biometric sensor system is configured to obtain a plurality of biometric images from the user, and where the control system is configured to buffer the plurality of biometric images and include, with a preceding biometric image of the plurality of biometric images, a hash of a subsequent biometric image of the plurality of biometric images.
4. The apparatus of any one of clauses 1–3, where the biometric sensor system is configured to obtain a plurality of biometric images from the user, and where the watermark is spread across the plurality of biometric images.
5. The apparatus of any one of clauses 1–4, where the watermark encodes at least one of a timestamp, an apparatus identifier, a payment terminal identifier, a session identifier, a nonce, or a value associated with a pairing between the apparatus and the payment terminal.
6. The apparatus of any one of clauses 1–5, where the control system is configured to receive a personalized watermark from a user mobile device and add the personalized watermark to the biometric image.
7. The apparatus of any one of clauses 1–6, where the control system is configured to provide at least one of encryption keys or a nonce associated with the watermarked encrypted biometric image to a cloud system for storage and audit.
8. The apparatus of any one of clauses 1–7, where the control system is configured to attach a hash message authentication code to the watermarked encrypted biometric image.
9. The apparatus of any one of clauses 1–8, where the control system is configured to perform an anti-spoof check or a liveness check.
10. The apparatus of any one of clauses 1–9, where the watermark varies over time.
11. The apparatus of any one of clauses 1–10, where the second device is a payment terminal, an access control terminal or a server.
12. A method, including: obtaining, via a biometric sensor system of a first device, a biometric image from a user; producing, via a control system, a watermarked encrypted biometric image by:
   (i) encrypting the biometric image to produce an encrypted biometric image and adding a watermark to the encrypted biometric image, or
   (ii) adding the watermark to the biometric image to produce a watermarked biometric image and encrypting the watermarked biometric image; and providing the watermarked encrypted biometric image to a second device for authentication.
13. The method of clause 12, where the watermark is visible or invisible, and where the watermark covers an entire area of the encrypted biometric image or a partial area of the encrypted biometric image.
14. The method of clause 12 or clause 13, further including: obtaining a plurality of biometric images from the user; and spreading the watermark across the plurality of biometric images.
15. The method of clause 14, further involving including, with one biometric image of the plurality of biometric images, a hash of a subsequent biometric image of the plurality of biometric images.
16. The method of any one of clauses 12–15, where the watermark is, or includes, a personalized watermark, further including receiving the personalized watermark from a user’s mobile device.
17. The method of any one of clauses 12–16, further including providing at least one of encryption keys or a nonce associated with the watermarked encrypted biometric image to a cloud system for storage and audit.
18. The method of any one of clauses 12–17, where the second device is a payment terminal and where the authentication is for a transaction, further including: evaluating, via the payment terminal or a cloud system, the watermark based on one or more keys; and denying the transaction based on detecting tampering of the watermark.
19. The method of any one of clauses 12–18, further including performing an anti-spoof check or a liveness check.
20. The method of any one of clauses 12–19, where the watermark encodes at least one of a timestamp, a first device identifier, a payment terminal identifier, a session identifier, a nonce, or a value associated with a pairing between the first device and the second device.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations presented herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order presented or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

What is claimed is:

1. An apparatus, comprising:
a biometric sensor system configured to obtain a biometric image from a user; and
a control system configured to:
produce a watermarked encrypted biometric image wherein:
(i) to produce the watermarked encrypted biometric image, the control system is configured to encrypt the biometric image to produce an encrypted biometric image and to add a watermark to the encrypted biometric image, or
(ii) to produce the watermarked encrypted biometric image, the control system is configured to add the watermark to the biometric image to produce a watermarked biometric image and to encrypt the watermarked biometric image; and
provide the watermarked encrypted biometric image to a second device for authentication.

2. The apparatus of claim 1, wherein the watermark is visible or invisible, and wherein the watermark covers an entire area of the encrypted biometric image or a partial area of the encrypted biometric image.

3. The apparatus of claim 1, wherein the biometric sensor system is configured to obtain a plurality of biometric images from the user, and wherein the control system is configured to buffer the plurality of biometric images and include, with a preceding biometric image of the plurality of biometric images, a hash of a subsequent biometric image of the plurality of biometric images.

4. The apparatus of claim 1, wherein the biometric sensor system is configured to obtain a plurality of biometric images from the user, and wherein the watermark is spread across the plurality of biometric images.

5. The apparatus of claim 1, wherein the watermark encodes at least one of a timestamp, an apparatus identifier, a payment terminal identifier, a session identifier, a nonce, or a value associated with a pairing between the apparatus and the payment terminal.

6. The apparatus of claim 1, wherein the control system is configured to receive a personalized watermark from a user mobile device and add the personalized watermark to the biometric image.

7. The apparatus of claim 1, wherein the control system is configured to provide at least one of encryption keys or a nonce associated with the watermarked encrypted biometric image to a cloud system for storage and audit.

8. The apparatus of claim 1, wherein the control system is configured to attach a hash message authentication code to the watermarked encrypted biometric image.

9. The apparatus of claim 1, wherein the control system is configured to perform an anti-spoof check or a liveness check.

10. The apparatus of claim 1, wherein the watermark varies over time.

11. The apparatus of claim 1, wherein the second device is a payment terminal, an access control terminal or a server.

12. A method, comprising:
obtaining, via a biometric sensor system of a first device, a biometric image from a user;
producing, via a control system, a watermarked encrypted biometric image by:
(i) encrypting the biometric image to produce an encrypted biometric image and adding a watermark to the encrypted biometric image, or
(ii) adding the watermark to the biometric image to produce a watermarked biometric image and encrypting the watermarked biometric image; and
providing the watermarked encrypted biometric image to a second device for authentication.

13. The method of claim 12, wherein the watermark is visible or invisible, and wherein the watermark covers an entire area of the encrypted biometric image or a partial area of the encrypted biometric image.

14. The method of claim 12, further comprising:
obtaining a plurality of biometric images from the user; and
spreading the watermark across the plurality of biometric images.

15. The method of claim 14, further comprising including, with one biometric image of the plurality of biometric images, a hash of a subsequent biometric image of the plurality of biometric images.

16. The method of claim 12, wherein the watermark comprises a personalized watermark, further comprising receiving the personalized watermark from a user’s mobile device.

17. The method of claim 12, further comprising providing at least one of encryption keys or a nonce associated with the watermarked encrypted biometric image to a cloud system for storage and audit.

18. The method of claim 12, wherein the second device is a payment terminal and wherein the authentication is for a transaction, further comprising:
evaluating, via the payment terminal or a cloud system, the watermark based on one or more keys; and
denying the transaction based on detecting tampering of the watermark.

19. The method of claim 12, further comprising performing an anti-spoof check or a liveness check.

20. The method of claim 12, wherein the watermark encodes at least one of a timestamp, a first device identifier, a payment terminal identifier, a session identifier, a nonce, or a value associated with a pairing between the first device and the second device.
